(19) United States
(12) Patent Application Publication
(10) Pub. No.: US 2022/0383590 A1
(43) Pub. Date: Dec. 1, 2022

(54) METHOD FOR THE AUTOMATED DETERMINATION OF CHARACTERISTIC CURVES AND/OR CHARACTERISTIC MAPS

(71) Applicant: ELPRO GMBH, Berlin (DE)

(72) Inventor: Wladimir DEGTJAREW, Berlin (DE)

(73) Assignee: ELPRO GMBH, Berlin (DE)

(21) Appl. No.: 17/773,627

(22) PCT Filed: Oct. 29, 2020
(86) PCT No.: PCT/EP2020/080421

§ 371 Date: May 2, 2022

(30) Foreign Application Priority Data
Oct. 30, 2019 (DE) 10 2019 129 385.5

(51) Int. Cl. G06T 17/00; G06F 17/40

(52) U.S. Cl. CPC G06T 17/00; G06F 17/40

(57) ABSTRACT

The invention relates to a method for the automated determination of characteristic curves and/or characteristic maps of devices, which comprises the following method steps: acquisition of a measurement data set, execution of an iteration method with the iteration steps calculation of an iteration result from the measurement data set using a neural network, acquisition of a termination parameter, checking the termination parameter and terminating the iteration method if the termination parameter matches a termination criterion, as well as the optical visualization of the iteration result and the measurement data set and repeating the iteration steps.

The invention relates to a method for the automated determination of characteristic curves and/or characteristic maps of devices, which comprises the following method steps: acquisition of a measurement data set, execution of an iteration method with the iteration steps calculation of an iteration result from the measurement data set using a neural network, acquisition of a termination parameter, checking the termination parameter and terminating the iteration method if the termination parameter matches a termination criterion, as well as the optical visualization of the iteration result and the measurement data set and repeating the iteration steps.

### STATE OF THE ART

The quantitative relationship between two physical quantities can be represented by means of a characteristic curve. Other additional variables are represented by a map, which has a common coordinate system. The physical quantities are generated by measurement data sets that are supplied, for example, by a sensor system used to monitor a device. In order to be able to predict the behavior of the device also in the areas for which no or only few measurement data sets are available, the behavior of the device is modeled. For this purpose, the parameters of the measurement data sets are estimated by means of a polynomial of the nth degree; usual methods are regression and/or a determination of a fit function. Usually, the calculation is done by specifying the degree of the polynomial based on e.g. empirical values and then applying the least squares method. If the fit function has reached a certain defined termination criterion (e.g. MSE=0.005), i.o.w. the fit function is sufficiently well matched to the measurement data sets, the calculation is terminated. The goal of the balancing calculation is that the model is fitted to the measurement data sets in the best possible way. This is displayed together with the measurement data sets in a two- or multi-dimensional coordinate system.

This method, which has been used until now, has disadvantages. The user must know the degree of the polynomial of the fit function and enter it as initial values in the calculation of the fit function. The user must therefore have experience with the device to be monitored in order to be able to define sensible start values. The computational effort and the associated computational time can be very high, and the computation of the model is accordingly time-consuming, especially if the behavior of the device is determined by more than two input or output parameters.

It is therefore the object of the present invention to provide a method for the automated determination of characteristic curves and/or maps of devices, by means of which characteristic curves or maps can be determined more quickly, with less effort and with fewer errors.

The object is solved by a method for automated determination of characteristic curves and/or characteristic maps of devices according to claim 1. Further advantageous embodiments of the invention are set forth in the dependent claims.

The method according to the invention for the automated determination of characteristic curves and/or maps has four method steps: In the first method step, a measurement data set is acquired. For this purpose, a sensor system is installed on the device to be monitored. One or more measured values of the sensor system that are acquired at a specific point in time form a measurement data set. The sensor system transmits the measurement data set to an evaluation unit.

In the sense of the invention, a measurement data set contains raw data provided by a sensor system and/or determined values that are determined based on raw data provided by a sensor system. Exemplary volume, energy and time are such measurement data. Measurement data sets are measured values that additionally have one or more associated values supplied from outside the sensor system. The measurement data sets can also and/or additionally be key figures determined from measurement values. For example, a measurement data set can be the volume of a gas, the energy used to compress the gas, the energy cost, and the time spent to compress it. Parameters are measurement data, measurement data sets and/or other values generated inside and/or outside the sensor system.

In the second method step, the evaluation unit carries out an iteration method to calculate the characteristic curve or characteristic surface. The iteration method itself has four steps: In the first step of the iteration method, an iteration result is calculated based on the acquired measurement data set. According to the invention, a neural network is advantageously used for the calculation.

It has been found that the calculation by a neural network provides meaningful results much more often than a calculation of the characteristic curve or characteristic surface by means of previously known methods. Especially if the neural network has been trained, e.g. by already determining characteristic curves or maps of a multitude of similar devices by means of the neural network. Another advantage is that even if the characteristic curve or map is unknown, it can be evaluated quickly and with sufficient accuracy, e.g. if a characteristic curve or map is being determined for a device for the first time.

In the second method step of the iteration method, a termination parameter is acquired and checked in the third method step of the iteration method. In the fourth step of the iteration method, the iteration method is terminated if the termination parameter matches a termination criterion. A termination criterion can be e.g. a low MSE of the characteristic curve or the characteristic map, or an evaluation of the characteristic curve or the characteristic map by a user.

In the third method step of the method according to the invention for the automated determination of characteristic curves and/or maps, an optical visualization of the iteration result takes place together with the measurement data set.

In the fourth and last method step of the method according to the invention, the iteration steps of the iteration method are repeated if the termination parameter does not match a termination criterion, i.e. if the MSE of the determined characteristic curve or map is too large and/or a user considers the quality of the characteristic curve or map to be insufficient by optical validation.

The characteristic curves and/or maps determined by the method according to the invention can be used to monitor a drive or predict its performance and energy consumption. Various methods are known to determine such functions, but they are all quite complex.

When determining a drive map, for example, a drive is run in all possible operating modes and its power/speed/efficiency is measured. Subsequently, a matrix is created from the measured values. The values between the matrix values are interpolated. A disadvantage of such a method is on the one hand that a drive must first pass through all possible operating modes, and on the other hand in the creation of the matrix.

Another possibility is the automated determination of characteristic curves and/or a characteristic map by a neural network. In this process, a neural network is trained on a data set. The difficulty of training a neural network is to achieve a trade-off between sufficiently accurate modeling of the device to be monitored on the one hand, and sufficient training time on the other. There are two problems with this method: On the one hand, a neural network also remembers all errors in a data set, acting as a black box itself. It is difficult to validate how well a data set has been trained. On the other hand, it is difficult to find a suitable configuration of a neural network as well as the optimal training time. In a suboptimal configuration, the neural networks tend to “overfitting” or “underfitting”.

For validation of the determined characteristic curve and/or the determined characteristic map, the optical visualization of the iteration result is used together with the measurement data set. If the MSE of the determined characteristic curve or map is low enough (e.g. less than 0.005) or does not show any significant changes after a plurality of iteration methods executed in succession, the iteration method is terminated. But even with low MSE, the determined characteristic curve or map can be incorrect. By displaying the characteristic curve or the characteristic map in a coordinate system together with the measurement data records, the user receives a visualization of the characteristic curve or the characteristic map and can thus visually check the quality of the characteristic curve or the characteristic map. By means of this advantageous optical visualization, a user can thus very quickly, reliably and intuitively recognize both the quality of the characteristic curve or map and the learning success of the neural network.

The structure of a neural network is sufficiently known from the literature: A neural network consists of several layers of artificial neurons (nodes) that are interconnected. The number of neurons in the input layer corresponds to the number of input parameters, likewise the number of neurons in the output layer corresponds to the number of output parameters. Between input and output layers N so-called hidden layers with K neurons per layer are positioned. Experience shows that neural networks with N=5-10 and K=50-100 give good results. The neural network learns by adjusting the internal weights of neuron connections and their activation thresholds. The total error of the neural network is minimized.

The method according to the invention is not limited to only one application and/or type of plant; characteristic curves and/or maps can also be validated quickly and reliably for various conceivable applications.

In another embodiment of the invention, the termination parameter is a measure of deviation from the measurement data set and/or a user input. According to the invention, the termination parameter can be set in two ways, namely by the MSE of the characteristic curve or map, or manually by a user. A user can therefore terminate the method according to the invention at any time, either because the determined characteristic curve and/or the determined characteristic map is sufficiently good, or if it turns out that the neural network is operating incorrectly.

In a further embodiment of the invention, the termination criterion is a specification for the deviation from the measurement data set and/or a completed user input. The termination criterion can be set in two ways, namely by the MSE of the characteristic curve or map, or manually by a user.

In a further development of the invention, the optical visualization is part of the iteration steps. The optical visualization takes place after a number of iteration steps that can be specified by the user, so a user can promptly validate the determined characteristic curve and/or the determined characteristic map and, if necessary, terminate the method according to the invention.

In another embodiment of the invention, the optical visualization is part of each iteration run. The optical visualization takes place after each iteration step, so a user can validate the determined characteristic curve and/or the determined characteristic map after each iteration step and terminate the method according to the invention if necessary.

In a further embodiment of the invention, the optical visualization is performed after the calculation of the iteration result. The optical visualization takes place after each or a plurality of iteration steps, so a user can promptly validate the determined characteristic curve and/or the determined characteristic map and, if necessary, abort or terminate the method according to the invention.

In a particularly advantageous embodiment of the invention, the optical visualization is performed in a 3D graphic or a 4D graphic. This allows the visualization of three or four parameters. Three parameters are assigned to the three spatial directions, the fourth parameter is visualized by e.g. a color coding. The characteristic map determined by the method according to the invention is then two-dimensional. For reasons of better clarity, the 4D graphic can be rotated and changed in perspective by a user, for example, and subsections can also be zoomed.

In another embodiment of the invention, the iteration method is performed for a subsection of the measurement data set. This allows the calculation time for determining the characteristic curve and/or the characteristic map to be reduced by using only the measurement data set that is of interest to a user for the determination. Likewise, the clarity in the optical visualization is increased.

In another embodiment of the invention, the iteration method is performed for several subsections of the measurement data set. This allows the calculation time for determining the characteristic curve and/or the characteristic map to be reduced by using only the measurement data sets that are of interest to a user for the determination. Likewise, the clarity in the optical visualization is increased.

In a further embodiment of the invention, the iteration method accesses the same neural network for each subsection. This reduces the overhead compared to accessing different neural networks. When using a learned neural network, the computational effort is also reduced with a simultaneous increase in the quality of the determined characteristic curve and/or the determined characteristic map.

In an advantageous embodiment of the invention, the characteristic curve and/or characteristic map is used to make a prediction about the development of the output parameters of the device. Due to this advantageous design, the device does not have to run through all operating modes in order to determine a characteristic curve and/or a characteristic map. The time between installation and commissioning of the monitored device is thus significantly reduced.

In another embodiment of the invention, the characteristic curve and/or characteristic map is associated with a point in time. By means of this advantageous design, a user is able to monitor the behavior of the device even over a longer period of time. In particular, this allows a user to recognize any maintenance measures that may be necessary if the characteristic curve and/or the characteristic map shows changes over time. Maintenance measures that have been carried out can also be validated.

In a further embodiment of the invention, the characteristic curve and/or characteristic map and the associated point in time are stored. By means of this training, a user is able to monitor the behavior of the device even over a longer period of time. In particular, this allows a user to recognize any maintenance measures that may be necessary if the characteristic curve and/or the characteristic map shows changes over time. Maintenance measures that have been carried out can also be validated.

In a further embodiment of the invention, the characteristic curve and/or characteristic map is used to monitor the device during operation. Temporal changes in the characteristic curve and/or characteristic map may indicate a faulty component of the device or inefficient operation of the device. In this way, maintenance measures can be taken before the device breaks down or comes to a standstill.

In a further embodiment of the invention, the change in the characteristic curve and/or characteristic map of the device is monitored. Temporal changes in the characteristic curve and/or characteristic map may indicate a faulty component of the device or inefficient operation of the device. In this way, maintenance measures can be taken before the device breaks down or comes to a standstill.

In an optional embodiment of the invention, the sum of the number of input parameters and the number of output parameters is equal to the number of displayed dimensions of a graphic output in the optical visualization. Similarly, the sum of the number of input neurons and the number of output neurons of the neural network is equal to the number of dimensions of the graphic output in the optical visualization. Each input and/or output parameter and/or each input and output neuron is represented in a separate dimension of the output graphic.

In the following, an embodiment of the present invention is explained in more detail with reference to drawings. Showing:

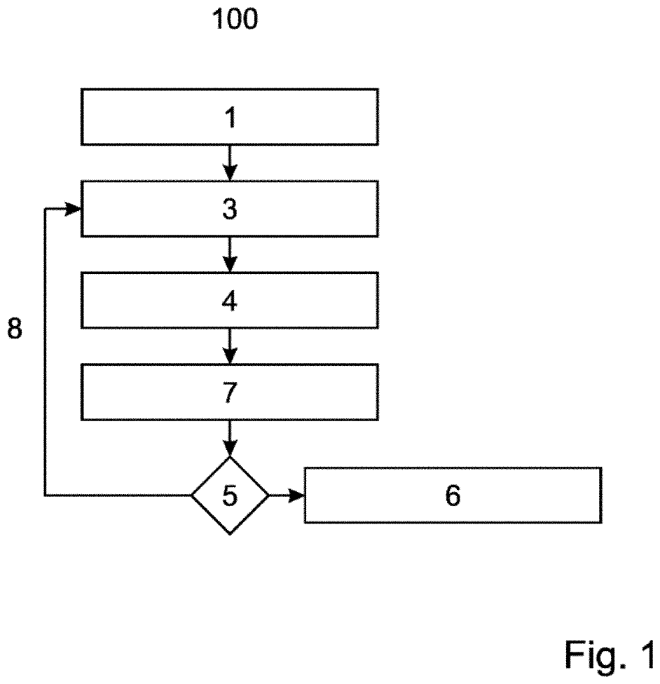

FIG. 1: An embodiment example of the method for the automatic determination of characteristic curves and/or characteristic maps

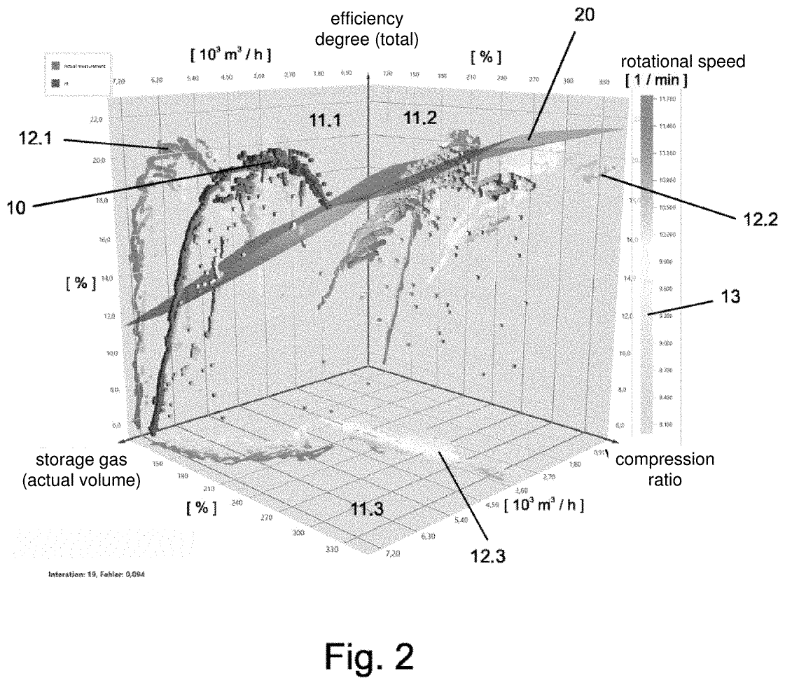

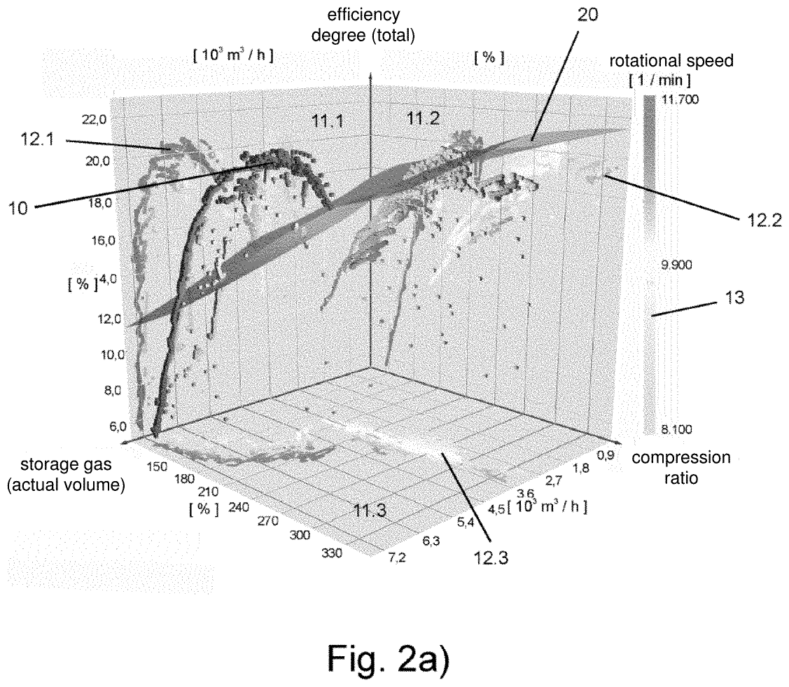

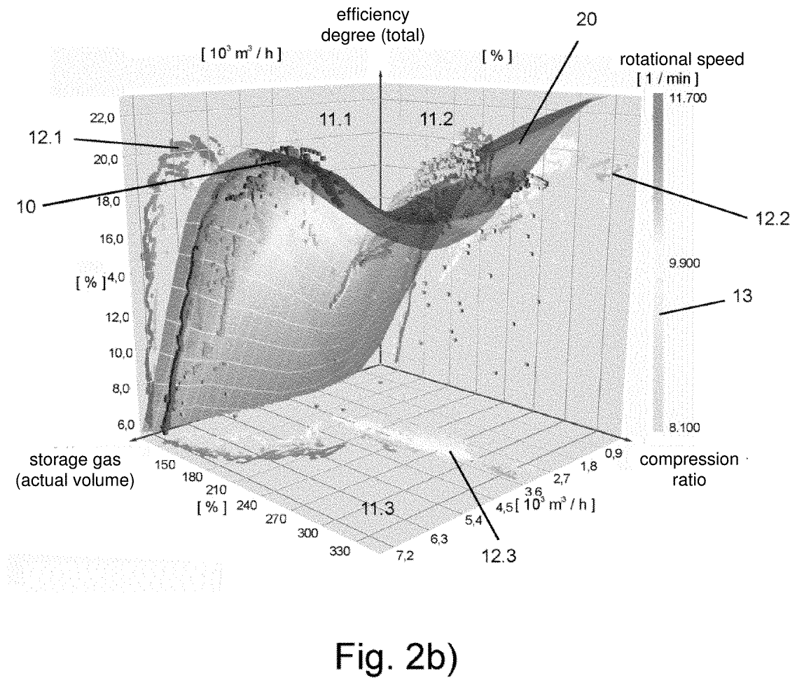

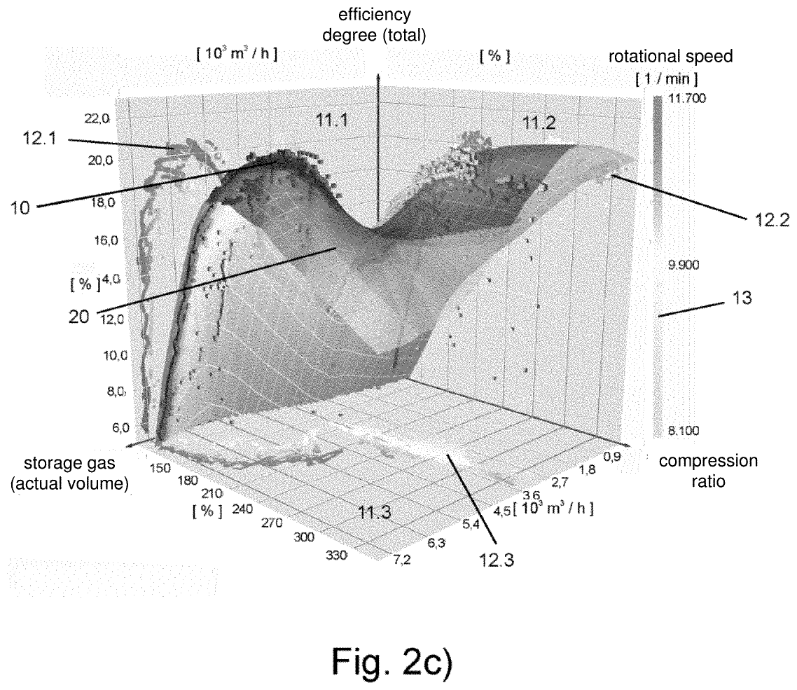

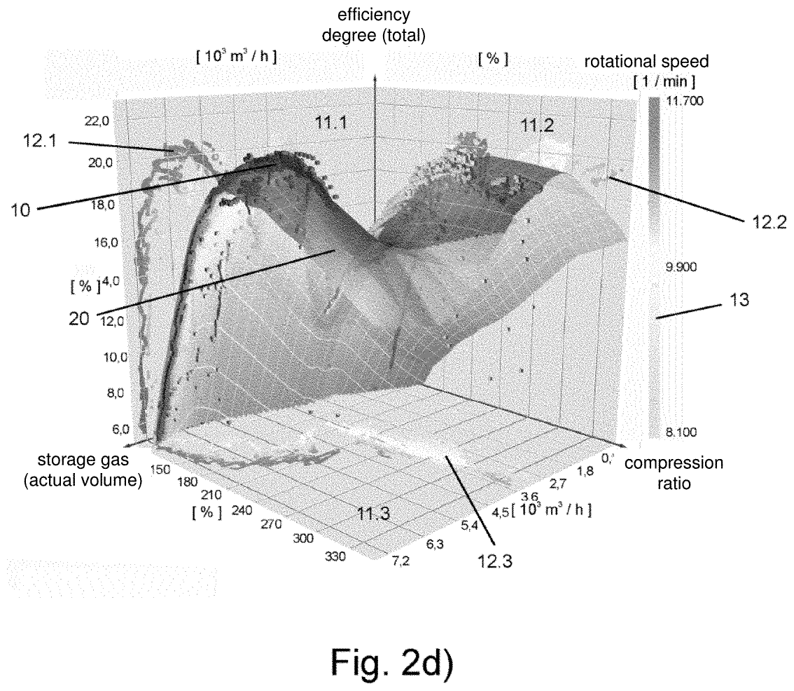

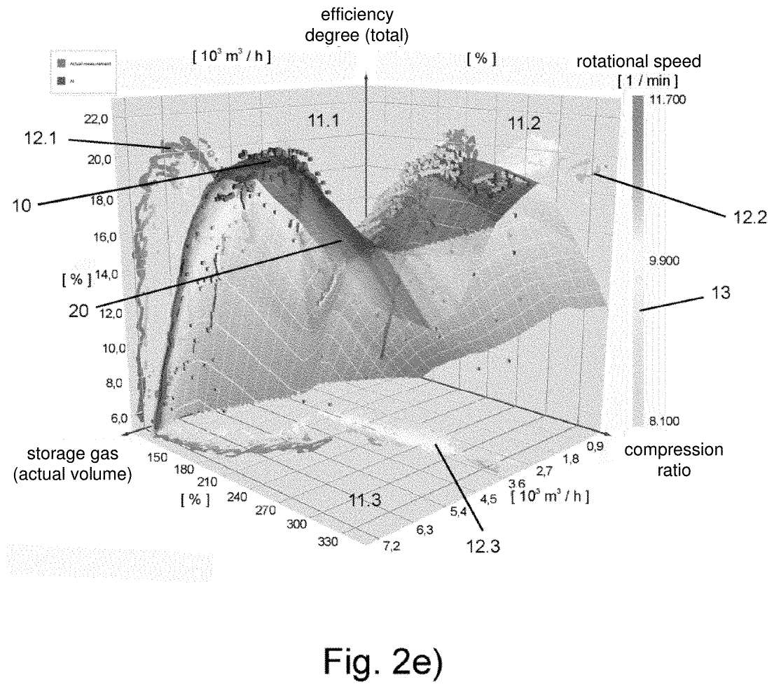

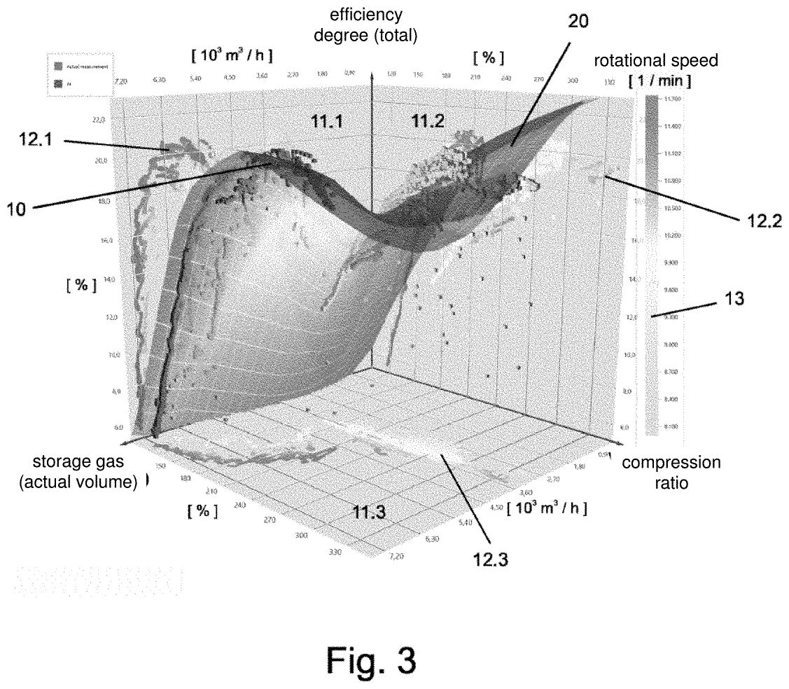

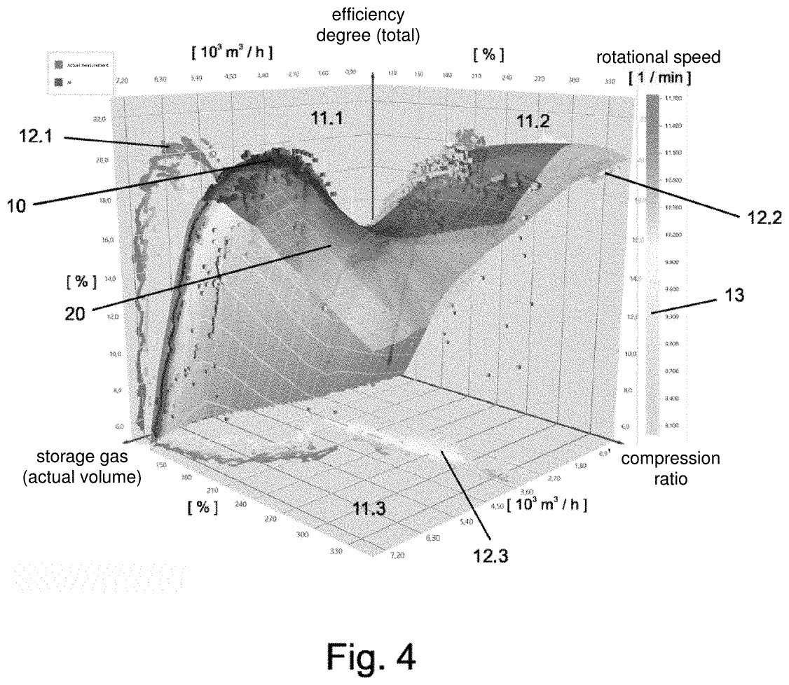

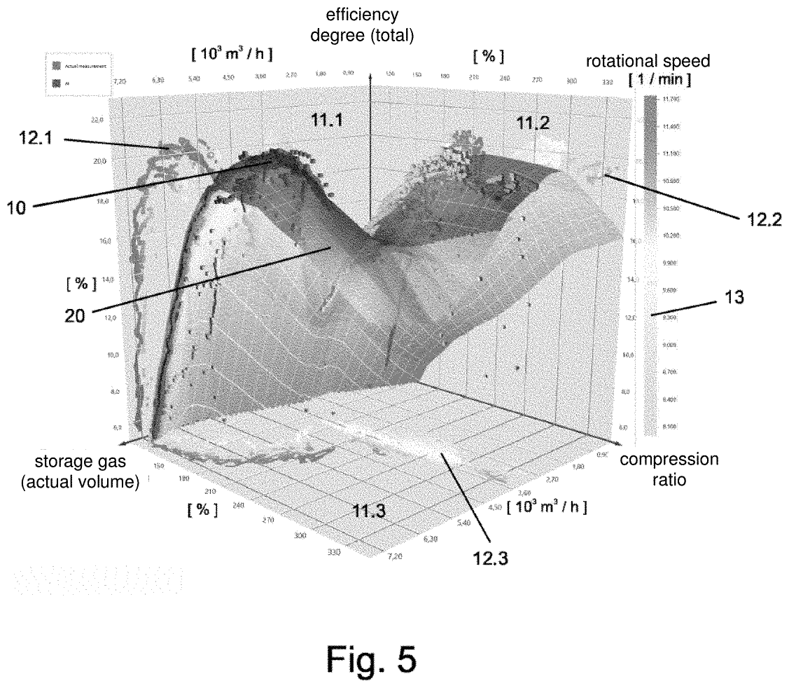

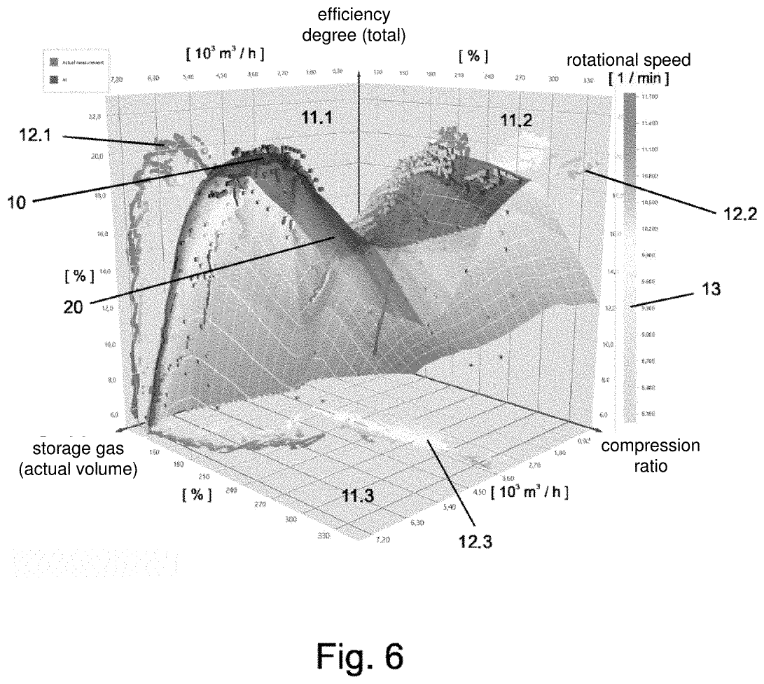

FIG. 2 a: 4D visualization of the measurement data sets of a two-stage gas compressor, method according to the invention for the automatic determination of characteristic curves and/or characteristic maps after 19 iteration steps

FIG. 2 b: 4D visualization of the measurement data sets of a two-stage gas compressor, method according to the invention for the automatic determination of characteristic curves and/or characteristic maps after 693 iteration steps

FIG. 2 c: 4D visualization of the measurement data sets of a two-stage gas compressor, method according to the invention for the automatic determination of characteristic curves and/or characteristic maps after 2097 iteration steps

FIG. 2 d: 4D visualization of the measurement data sets of a two-stage gas compressor, method according to the invention for the automatic determination of characteristic curves and/or characteristic maps after 3729 iteration steps

FIG. 2 e: 4D visualization of the measurement data sets of a two-stage gas compressor, method according to the invention for the automatic determination of characteristic curves and/or characteristic maps after 6641 iteration steps

FIG. 1 shows of an exemplary embodiment of a method according to the invention. The method 100 according to the invention has several method steps: In the first method step, a measurement data set is acquired 1. For this purpose, a sensor system is installed on the device to be monitored. One or more measured values of the sensor system that are acquired at a specific point in time form a measurement data set 1. The sensor system transmits the measurement data set to an evaluation unit. To calculate the characteristic curve or characteristic surface 20, an iteration method is performed and an iteration result is calculated 3. The iteration method 3 itself has four method steps for this purpose: In the first step 3 of the iteration method, an iteration result is calculated based on the acquired measurement data set 1. According to the invention, a neural network 30 is advantageously used for the calculation.

It has been found that the calculation by a neural network 30 provides useful results much more frequently than a calculation of the characteristic curve or characteristic surface 20 by means of previously known methods. In particular, if the neural network 30 has been taught, e.g., in that characteristic curves or maps 20 of a plurality of similar devices have already been determined by means of the neural network 30. Another advantage is that even if the characteristic curve or map 20 is unknown, it can be evaluated quickly and with sufficient accuracy, e.g. if a characteristic curve or map 20 is being determined for a device for the first time.

In the second method step for calculating the iteration result 3, a termination parameter is acquired 4. According to the invention, the termination parameter can be set in two ways, namely by the MSE of the characteristic curve or map 20 or manually by a user.

In the next method step of the method according to the invention for the automated determination of characteristic curves and/or maps 20, an optical visualization 7 of the iteration result takes place together with the measurement data set.

After that, the termination parameter is checked 5. The calculation of the iteration result 3 is terminated 6 if the termination parameter matches an termination criterion. A termination criterion can be e.g. a low MSE of the characteristic curve or the characteristic map 20, or an evaluation of the characteristic curve or the characteristic map 20 by a user.

In the last method step of the method according to the invention, the iteration steps of the iteration method 3 are repeated 8 if the termination parameter does not match a termination criterion, i.e. if the MSE of the determined characteristic curve or map 20 is too large and/or a user considers the quality of the characteristic curve or map 20 to be insufficient by optical validation.

Thus, if the MSE of the determined characteristic curve or map 20 is small enough (e.g., less than 0.005) or does not show significant changes after a plurality of iteration methods 3 executed in succession, the iteration method 3 is terminated. But even with low MSE, the determined characteristic curve or map 20 can be incorrect. By displaying the characteristic curve or the characteristic map 20 in a coordinate system together with the measurement data records, the user receives a visualization of the characteristic curve or the characteristic map 20 at each iteration step of the iteration method 3 and can thus visually check the quality of the characteristic curve or the characteristic map 20. By means of this advantageous optical visualization 7, a user can thus very quickly, reliably and intuitively recognize both the quality of the characteristic curve or map 20 and the learning success of the neural network 30.

An embodiment of the method 100 according to the invention is shown in FIGS. 2 a) to 2 e). As an example, an underground gas storage facility is used as the device to be monitored. These storage facilities serve to balance out imbalances between supply or production and demand or consumption and thus to increase security of supply. Since the gas in the underground storage facility usually has a higher pressure than the long-distance gas pipeline, the gas is compressed for injection by means of one or—as in this exemplary embodiment—by means of two gas compressors.

A 3D representation was selected for visualization, in which a color and/or brightness coding 13 was assigned to the measuring points 10 displayed in the 3D representation to represent the 4th dimension. The surfaces 11.1, 11.2, 11.3 between the coordinate axes are shown as projection surfaces, on each of which the measuring points 10 are projected as projected points 12.1, 12.2, 12.3. Furthermore, the determined map 20 is drawn.

The method 100 according to the invention has several method steps: In the first method step, a measurement data set is acquired 1. For this purpose, a sensor system is installed on the device to be monitored. One or more measured values of the sensor system that are acquired at a specific point in time form a measurement data set 1. The sensor system transmits the measurement data set to an evaluation unit. To calculate the characteristic curve or characteristic surface 20, an iteration method is performed and an iteration result is calculated 3. The iteration method 3 itself has four method steps for this purpose: In the first step 3 of the iteration method, an iteration result is calculated based on the acquired measurement data set 1. According to the invention, a neural network 30 is advantageously used for the calculation.

In the second method step for calculating the iteration result 3, a termination parameter is acquired 4. According to the invention, the termination parameter can be set in two ways, namely by the MSE of the characteristic curve or map 20 or manually by a user.

In the next method step of the method according to the invention for the automated determination of characteristic curves and/or maps 20, an optical visualization 7 of the iteration result takes place together with the measurement data set.

After that, the termination parameter is checked 5. The calculation of the iteration result 3 is terminated 6 if the termination parameter matches an termination criterion. A termination criterion can be e.g. a low MSE of the characteristic curve or the characteristic map 20, or an evaluation of the characteristic curve or the characteristic map 20 by a user.

In the last method step of the method according to the invention, the iteration steps of the iteration method 3 are repeated 8 if the termination parameter does not match a termination criterion, i.e. if the MSE of the determined characteristic curve or map 20 is too large and/or a user considers the quality of the characteristic curve or map 20 to be insufficient by optical validation.

In this embodiment example, the sensor system provides measurement data sets on the volume flow of the gas fed into the storage facility (parameter 1, x-axis) and on the compression ratio of the natural gas in the storage facility (parameter 2, y-axis). These two parameters are entered into the neural network 30 in the input layer. The parameter efficiency (parameter 3, z-axis), which is particularly relevant for a user of the system, as well as the speed of the two gas compressors (parameter 4, gray scale) are the output and are output via the output layer of the neural network 30. Accordingly, the neural network 30 has 2 input neurons as well as 2 output neurons. The neural network 30 was trained using training data from various subsurface gas storage facilities. In the present example, two input neurons and two output neurons are used in each case. Between the input and output neurons there are another 5 hidden layers with 100 neurons each.

FIG. 2 shows the 4-dimensional optical visualization 7 of the measurement data sets together with the characteristic map 20 determined from them. The optical visualization 7 can be stored at different times in each case and thus assigned to the point in time. In this embodiment example, the optical visualization 7 as part of the iteration steps of the iteration method 2 is performed after each calculation of the iteration result 3. This illustrates the quality of the determined characteristic map 20 after the specified number of iteration steps (FIG. 2 a-e) and can be visually validated by a user. The MSE of the determined characteristic map 20 is also given.

After 19 iteration steps (FIG. 2 a), the characteristic map 20 still exhibits a very large MSE of 0.094. The characteristic map 20 still essentially has the shape of an inclined plane. It is visually apparent to a user alone that the calculated characteristic map 20 does not at this point in time approximately reflect the behavior of the gas injection into the underground gas storage facility.

After 693 iteration steps (FIG. 2 b), the MSE of the characteristic map 20 is still 0.007. The formation of two relative maxima can already be seen. The two relative maxima correspond to a serial and a parallel operation of the two gas compressors. Here, becomes apparent the advantage of the method 100 according to the invention of optically visualizing 7 the characteristic map 20. Despite the low MSE of the characteristic map 20 of 0.007, it is visually apparent that the behavior of the subsurface gas storage facility cannot yet be predicted correctly when compared with FIG. 2 c, in which characteristic map 20 has a larger error of 0.013.

After 2097 iteration steps (FIG. 2 c), the MSE of the characteristic map 20 has increased to 0.013, yet both relative maxima are much more pronounced visually. After 3729 iteration steps (FIG. 2 d), the MSE of the characteristic map 20 is still 0.0034, the significantly improved characteristic map 20 already shows the two relative maxima with a visually recognizable difference in efficiency. After 6641 iteration steps (FIG. 2 e), the MSE of the characteristic map is 0.0045, slightly increased compared to 3729 iteration steps (FIG. 2 d). However, the two relative maxima still show clearly visually distinguishable efficiencies: The maximum of the efficiency for the parallel mode is significantly lower than the maximum of the efficiency for a serial mode of the gas compressors. This also corresponds to the empirical values.

The characteristic maps 20 of both driving modes were not calculated separately in this embodiment example. Nevertheless, the method 100 according to the invention provides a well-validated characteristic map 20. The method 100 according to the invention also allows the characteristic map 20 to be determined even from one or more subsections of the measurement data records, by simply using only the measurement data records that are of interest to the user to determine the characteristic map and hiding the measurement data records that are not of interest. The method 100 according to the invention is very efficient; the characteristic map 20 shown in FIG. 2 e required a computing time of only 2 minutes.

### LIST OF REFERENCE SIGNS

100 Method for the automatic determination of characteristic curves and/or characteristic maps
1 Acquisition of a measurement data set
2 Execution of the iteration method
3 Calculation of an iteration result
4 Acquisition of the termination parameter
5 Checking the termination parameter
6 Termination of the iteration method
7 Optical visualization
8 Repetition of the iteration method
10 Measuring point of a measurement dataset
11.1, 11.2, 11.3 Surfaces between the coordinate axes
12.1, 12.2, 12.3 Projected measuring points
13 Color/brightness coding
20 Characteristic map
30 Neural network

1. Method for the automated determination of characteristic curves and/or characteristic maps (100) of devices, which comprises the following method steps:
Acquisition of a measurement data set (1)
Execution of an iteration method (2) with the iteration steps:
Calculation of an iteration result (3) from the measurement data set using a neural network (30)
Acquisition of a termination parameter (4)
Checking the termination parameter (5)
Termination of the iteration method (6) if the termination parameter matches a termination criterion
Optical visualization (7) of the iteration result and the measurement data set
Repeating the iteration steps (8)

2. Method for the automated determination of characteristic curves and/or characteristic maps (100) of devices according to claim 1,
characterized in that
the termination parameter is a measure of the deviation from measurement data set to iteration result and/or a user input.

3. Method for automated determination of characteristic curves and/or characteristic maps (100) of devices according to claim 1,
characterized in that
the termination criterion is a specification for the deviation of measurement data set to iteration result and/or an occurred user input.

4. Method for automated determination of characteristic curves and/or maps (100) of devices according to claim 1,
characterized in that
the optical visualization (7) is part of the iteration steps.

5. Method for the automated determination of characteristic curves and/or characteristic maps (100) of devices according to claim 4,
characterized in that
the optical visualization (7) is part of each iteration run (8).

6. Method for automated determination of characteristic curves and/or maps (100) of devices according to claim 1,
characterized in that
the optical visualization (7) takes place after the calculation of the iteration result (3).

7. Method for automated determination of characteristic curves and/or maps (100) of devices according to claim 1,
characterized in that
the optical visualization (7) is done in a 3D graphic or a 4D graphic.

8. Method for automated determination of characteristic curves and/or maps (100) of devices according to claim 1,
characterized in that
the iteration method (2) is performed for a subsection of the measurement data set.

9. Method for automated determination of characteristic curves and/or maps (100) of devices according to claim 1,
characterized in that
the iteration method (2) is performed for several subsections of the measurement data set.

10. Method for the automated determination of characteristic curves and/or characteristic maps (100) of devices according to claim 9,
characterized in that
the iteration method (2) accesses the same neural network (30) for each subsection.

11. Method for automated determination of characteristic curves and/or maps (100) of devices according to claim 1,
characterized in that
a prognosis and/or prediction about the development of the output parameters of the device is made with the aid of the characteristic curve or the characteristic map (20).

12. Method for automated determination of characteristic curves and/or maps (100) of devices according to claim 1,
characterized in that
the characteristic curve or map (20) is assigned to a point in time.

13. Method for the automated determination of characteristic curves and/or characteristic maps (100) of devices according to claim 12,
characterized in that
the characteristic curve and/or the characteristic map (20) and the assigned point in time are stored.

14. Method for automated determination of characteristic curves and/or maps (100) of devices according to claim 1,
characterized in that
the device is monitored during operation with the aid of the characteristic curve and/or the characteristic map (20).

15. Method for automated determination of characteristic curves and/or maps (100) of devices according to claim 1,
characterized in that
the change of the characteristic curve and/or the characteristic map (20) of the device is monitored.
